(19) United States
(12) Patent Application Publication
(10) Pub. No.: US 2025/0370734 A1
(43) Pub. Date: Dec. 4, 2025

(54) SYSTEMS AND METHODS FOR HARDWARE-IN-THE-LOOP AI FEEDBACK FOR PROCESSOR-OPTIMIZED CODE GENERATION WITH SELECTABLE METRICS

(71) Applicant: Code Metal, Boston, MA (US)

(72) Inventor: Peter Michael Morales, South Lake Tahoe, CA (US)

(21) Appl. No.: 18/680,631

(22) Filed: May 31, 2024

(51) Int. Cl. G06F 8/41; G06F 8/35

(52) U.S. Cl. CPC G06F 8/443; G06F 8/35

(57) ABSTRACT

A computing system is disclosed with hardware-in-the-loop AI feedback for processor-optimized code generation with selectable objective metrics. The computing system includes one or more processors; and one or more non-transitory computer-readable media collectively storing instructions that are collectively executed by the one or more processors, to cause the computing system to perform operations. The operations instruct the computing system to: interface, via a profiling module, with hardware or emulated hardware to collect execution data of input source code; train a large language model (LLM) to propose code optimization strategies based on code logic generalization across multiple programming languages; employ, via an optimization strategy discovery module, LLM-generated strategies to generate code optimization tasks; and apply, via a code transformation module, the generated code optimization tasks to the source code to produce an optimized version of the source code that is tailored to specific processing platforms.

### BACKGROUND

### Technical Field

The present disclosure generally relates to the field of computational hardware optimization, and more particularly, to computational hardware optimization with code generation tailored for data processing platforms.

### Description of the related art

Reinforcement Learning with Human Feedback (RLHF) is an approach in machine learning where a model is trained to perform tasks by leveraging feedback from humans. This technique combines traditional reinforcement learning (RL), in which a model learns to make decisions through trial and error to maximize a reward signal, with human feedback to guide the learning process more effectively. Humans provide evaluations or corrections to the model’s operations, which are then used as additional signals to refine the model’s behavior. This method helps in aligning the model’s objectives with human values and intentions, leading to more reliable and ethical AI systems. RLHF is particularly useful in complex decision-making tasks where predefined reward functions may not adequately capture the desired outcomes.

Reinforcement Learning with Human Feedback (RLHF) has demonstrated significant potential in creating AI systems that align closely with human values and intentions. However, the approach faces scalability challenges, especially in resource-constrained environments or situations requiring specialized expert input. The necessity for human involvement in providing feedback can limit the speed and extent of model training and improvement. In environments where experts are scarce or the cost of human labor is high, continuously obtaining detailed and high-quality feedback to guide the AI’s learning process becomes impractical. This limitation can hinder the deployment of RLHF in broader applications or in domains where rapid scaling of AI capabilities is critical.

RLAIF, or Reinforcement Learning with AI-generated Feedback, seeks to address the scalability challenges of RLHF by automating the feedback process. In RLAIF, the feedback typically provided by humans is instead generated by artificial intelligence systems. This approach aims to reduce the reliance on human experts, potentially lowering the costs and resources needed for training AI models. By using AI to generate feedback, RLAIF can facilitate more rapid and scalable training processes, making it feasible to apply reinforcement learning in more extensive and complex scenarios. However, ensuring that AI-generated feedback is of high quality and accurately aligns with human values remains a crucial challenge, necessitating advanced AI systems capable of understanding and evaluating the nuances of human preferences and decision-making criteria. For this reason, AI feedback may sometimes leverage external expert tools to generate the feedback in a Large Language Model (LLM) agentic manner.

### BRIEF SUMMARY

The code generation system and method of the present disclosure relates to code generation tailored for data processing platforms including but not limited to, System on Chips (SoCs), Field-Programmable Gate Arrays (FPGAs), and high-performance CPUs and GPUs. The system utilizes advanced machine learning models to create optimized code that is specific to the hardware’s architecture, enhancing performance and efficiency.

Additionally, the code generation system and method presents a novel approach to code generation that is optimized for specific hardware environments using hardware-in-the-loop (HWIL) feedback and Large Language Models (LLMs). This code generation system and method uses LLMs to discover and propose optimization strategies, thereby leveraging the versatility of code representation frameworks. Embodiments of this system and method uniquely combine optimization tools with AI-driven strategy discovery, in conjunction with comprehensive training across diverse processing platforms. This approach of the code generation system and method not only supports optimization for established hardware but also adapts to emerging and unconventional compute platforms. The system’s capability to integrate real or emulated HWIL feedback enables a dynamic optimization process, where the code is continuously refined in a feedback loop to meet various performance objectives, including but not limited to speed and energy efficiency.

Briefly stated, embodiments of the present disclosure are directed towards a code generation method facilitated by hardware-in-the-loop feedback. The method includes: interpreting input source code to an intermediate representation suitable for optimization analysis; generating code optimization strategies through a large language model (LLM) based on profiler reports and data flow analysis from deployed code on target hardware; creating generation tasks that modify the intermediate representation according to the generated optimization strategies to ensure compatibility with processor-specific architectures and desired performance objectives; and executing the generation tasks that modify the intermediate representation according to the proposed strategies.

In some embodiments, the code generation method further comprises: training the large language model (LLM) to propose code optimization strategies based on code logic generalization across multiple programming languages. In another aspect of some embodiments, the code generation method further comprises: refining the generated optimization strategies against selectable objective metrics. In still another aspect of some embodiments of the code generation method, the selectable objective metrics include one or more of speed, energy efficiency, and resource utilization. In yet another aspect of some embodiments, the code generation method further comprises: outputting hardware-optimized code that is modified for processor-specific architectures and desired performance objectives.

In another embodiment, a code generation method facilitated by hardware-in-the-loop feedback is disclosed. The method includes: interfacing, via a profiling module, with hardware or emulated hardware to collect execution data of input source code; training a large language model (LLM) to propose code optimization strategies based on code logic generalization across multiple programming languages; employing, via an optimization strategy discovery module, LLM-generated strategies to generate code optimization tasks; and applying, via a code transformation module, the generated code optimization tasks to the source code to produce an optimized version of the source code that is tailored to specific processing platforms.

In some embodiments of the code generation method, the LLM is trained on a multi-language data corpus for code-to-code translation. In another aspect of some embodiments, the code generation method further comprises: refining the LLM-generated strategies against selectable objective metrics. In still another aspect of some embodiments of the code generation method, the selectable objective metrics include one or more of speed, energy efficiency, and resource utilization. In yet another aspect of some embodiments, the code generation method further comprises: outputting optimized version of the source code that is tailored to specific processing platforms.

In still another embodiment, a method for iterative refinement to optimize code generation is disclosed. The method includes: dividing, via a generation planner module, a code optimization process into discrete, manageable tasks that enable incremental and targeted code improvements; adjusting, via a strategy adaptation module, code generation according to dynamic hardware feedback and optimization goals; implementing a continuous improvement loop that validates and refines the generated code via a cyclical process that employs a large language model (LLM) code optimizer, a profiler feedback, and a code transformation module; and outputting hardware-optimized code that maintains semantic integrity.

In one or more embodiments, the method for iterative refinement to optimize code generation further comprises: training the LLM code optimizer to propose strategies based on code logic generalization across multiple programming languages. In another aspect of some embodiments, the method for iterative refinement to optimize code generation further comprises: refining the generated code against selectable objective metrics. In still another aspect of some embodiments, the selectable objective metrics include one or more of speed, energy efficiency, and resource utilization. In another aspect of some embodiments, the method for iterative refinement to optimize code generation further comprises: receiving input source code that is execution data from hardware or emulated hardware.

In yet another embodiment, a method for verifying and optimizing processor-specific code generation is disclosed. The method includes: utilizing a code analyzer module to evaluate structural and performance implications of generated code against original input source code; refining code optimization strategies iteratively based on feedback from actual or emulated hardware performance metrics; incorporating an adaptable test harness into the code generation tasks; and validating an effectiveness of the refined code optimization strategies against selectable objective metrics.

In some embodiments of the method for verifying and optimizing processor-specific code generation, the selectable objective metrics include one or more of speed, energy efficiency, and resource utilization. In another aspect of some embodiments, the method further comprises: training the LLM code optimizer to propose the code optimization strategies based on code logic generalization across multiple programming languages. In still another aspect of some embodiments, the method further comprises: receiving original input source code that is execution data from hardware or emulated hardware. In yet another aspect of some embodiments, the method further comprises: outputting hardware-optimized code that is modified for processor-specific architectures and desired performance objectives.

The embodiments described in the present disclosure improve upon known data storage architectures, structures, processes, and techniques in a variety of different computerized technologies, such as operating systems, user interfaces, and social networks.

### BRIEF DESCRIPTION OF THE SEVERAL VIEWS OF THE DRAWINGS

Like-numbered elements may refer to common components in the different figures.

FIG. 1 is a block diagram illustrating a system including software components and data flow for code generation process according to some embodiments of the present disclosure.

FIG. 2A is a flow diagram illustrating a process for code generation process facilitated by hardware-in-the-loop feedback, according to some embodiments of the present disclosure.

FIG. 2B is a flow diagram illustrating a process for hardware-in-the-loop AI feedback using processor-optimized code generation with selectable objective metrics, according to some embodiments of the present disclosure.

FIG. 3A is a flow diagram illustrating a process for iterative refinement to optimize code generation, according to some embodiments of the present disclosure.

FIG. 3B is a flow diagram illustrating a process for verifying and optimizing processor-specific code generation, according to some embodiments of the present disclosure.

FIG. 4 is a block diagram illustrating a computing system or device used to implement some or all the functionalities of the technology disclosed herein.

### DETAILED DESCRIPTION

The area of code generation for specific hardware architectures and compute platforms is increasingly crucial as the variety of computing environments expands. Optimizing code for these diverse platforms often involves using domain-specific languages (DSLs), which restrict optimization efforts to particular algorithm families. This approach ensures that the code is well-suited to the targeted hardware’s capabilities.

Yet, the challenge intensifies without substantial training data encompassing the wide spectrum of hardware configurations and performance metrics. Legacy methods generally apply formal techniques during the compilation stage to narrow down the optimization search space. Additionally, such prior methods rely on established strategies for fine-tuning code performance on specific hardware. Such strategies, while somewhat effective for well-known hardware environments, does not take advantage of the optimization opportunities available for new or unconventional compute platforms.

The evolution of code generation technology necessitates developing methods that can dynamically adjust to various hardware specifications. Such advancements would benefit from broader and more diverse datasets, enabling the training of models capable of autonomously determining and applying the most effective code optimization strategies for any given hardware scenario. This would mark a significant leap forward, allowing for more efficient and optimized code performance across a wider array of computing environments.

As discussed above, the code generation system and method of the present disclosure outlines such a platform that is designed for generating optimized code tailored for bespoke configurations of data processing hardware. The data processing hardware may span all ranges of compute, from low-power microcontroller units (MCUs), through versatile single-board computers (SBCs), up to high-performance CPUs and GPUs in desktop environments, specialized systems like Application-Specific Integrated Circuits (ASICs) and Field-Programmable Gate Arrays (FPGAs), and scalable cloud computing platforms. The process begins with input source code and employs strategies informed by hardware-in-the-loop (HWIL) feedback, or its emulated counterpart, to enhance optimization. The framework leverages Large Language Models (LLMs) to discover and suggest new optimization strategies, while drawing on tools and methods for code optimization. Embodiments of these code generation systems and methods develop innovative strategies by interpreting the code logic in a general form. This is akin to a domain-specific language (DSL) used in traditional optimizers, yet broad enough to accommodate various types of input code such as Intermediate Representations (IR) languages or Abstract Syntax Trees (ASTs).

The platform is trained across a vast array of processing platforms, enabling the derived strategies to form a foundational model that is adept at generating code for both specific and novel general compute platforms. Part of this method includes generating benchmarking code, which aids in validating the proposed strategies and helps explore the strategy search space effectively.

One aspect of this system is the integration of hardware-in-the-loop feedback, utilizing either actual or emulated hardware, to steer the optimization process. Moreover, the platform enables feedback that targets objectives beyond mere speed, encompassing energy efficiency and other metrics assessable through system and unit testing. Significantly, this code generation system and method transcends the limitations of traditional domain-specific optimization frameworks and offers a generalized approach that harnesses the adaptability of AI optimizers to learn from specific hardware feedback and implement uniquely discovered optimization strategies.

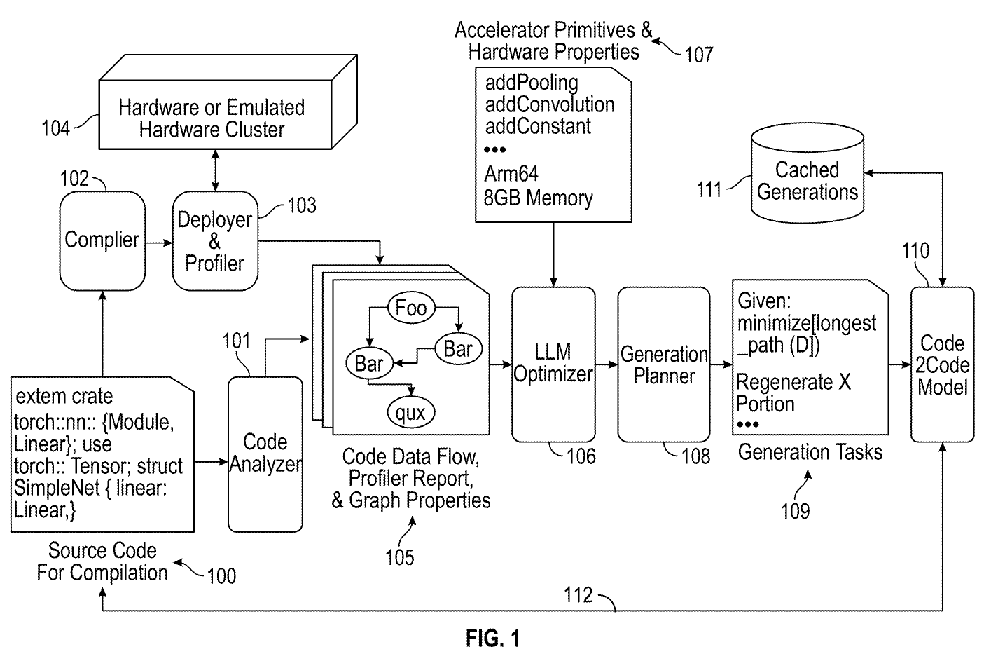

FIG. 1 is a block diagram illustrating one embodiment of a system 100 for hardware-in-the-loop AI feedback for processor-optimized code generation with selectable objective metrics. In one or more embodiments, the system 100 depicted in FIG. 1 involves several interconnected components working together to optimize source code for specific hardware architectures using large language models (LLMs) and hardware-in-the-loop feedback. In the embodiment shown in FIG. 1, these interconnected components include Source Code for a Compilation 100, a Code Analyzer 101, a Compiler 102, a Deployer and Profiler Module 103, a Hardware (or Emulated Hardware) Cluster 104, Code Data Flow/Profiler Report/Graph Properties Module 105, an LLM Optimizer 106, an Accelerator Primitives/Hardware Properties Module 107, a Generation Planner 108, Generation Tasks 109, a Code2Code Model 110, and Cached Generations 111.

Referring now to these interconnected components in further detail, the Source Code for Compilation 100, is the initial code provided by the user for the optimization process, which may include various languages and is compilation-ready. As shown in FIG. 1, the Source Code for Compilation 100 can proceed in two ways. First, the Source Code for Compilation 100 can proceed to the Compiler 102. Second, the Source Code for Compilation 100 can proceed to the Code Analyzer 101.

Referring now to the Code Analyzer 101, this component is configured to perform static analysis or other applicable structural analysis on input source code, generated code (via a feedback loop 112), and/or parts thereof. The Code Analyzer 101 can create hierarchies, graphs, or other representations that cover the dependencies between structural blocks of code or code parts, annotate as needed with meta data, and utilize traditional representations such as Abstract Syntax Trees (ASTs). Other code graphing methods may also be able to create the needed code representations for examination. Additionally, the Code Analyzer 101 can detect and pinpoint problematic or deficient part(s) of source code.

As discussed above, in some embodiments, Source Code for Compilation 100 proceeds to the Compiler 102. The compiler is responsible for converting the Source Code for Compilation 100 into an intermediate representation of the code that is more suitable for analysis and transformation by the subsequent stages of the system 100 for hardware-in-the-loop AI feedback for processor-optimized code generation.

After the Source Code for Compilation 100 has been converted into an intermediate representation of the code by the Compiler 102, the intermediate representation of the code then proceeds to the Deployer Module 103A and Profiler Module 103B. As shown in FIG. 1, after the code is compiled, the Deployer Module 103A and Profiler Module 103B work in tandem to deploy the intermediate representation of the code onto the Hardware (or Emulated Hardware) Cluster 104 and to profile the performance of the intermediate representation of the code. Specifically, the Deployer Module 103A deploys the intermediate representation of the code onto the Hardware (or Emulated Hardware) Cluster 104, and the Profiler Module 103B gathers data regarding the performance of the intermediate representation of the code on the Hardware (or Emulated Hardware) Cluster 104 that is used to guide the optimization process. The Hardware (or Emulated Hardware) Cluster 104 represents the physical or emulated hardware where the code is deployed by the Deployer Module 103A and then executed. The performance data collected here by the Profiler Module 103B feeds back into the system 100 to inform optimization decisions.

After the intermediate representation of the code has been deployed by the Deployer Module 103A and has its performance profiled by the Profiler Module 103B, the output moves on to the Code Data Flow/Profiler Report/Graph Properties Module 105. As shown in FIG. 1, the Code Data Flow/Profiler Report/Graph Properties Module 105 also receives output from the Code Analyzer 101. Accordingly, the Code Data Flow/Profiler Report/Graph Properties Module 105, processes the output from the Profiler Module 103B and the Code Analyzer 101. In some embodiments, the Code Data Flow/Profiler Report/Graph Properties Module 105 provides a detailed report on how the intermediate representation of the code performs on the hardware, as well as a graph-based representation of the code’s structure and data flows.

Next, the intermediate representation of the code proceeds from the Code Data Flow/Profiler Report/Graph Properties Module 105 to the Large Language Model (LLM) Optimizer 106. Referring now to the LLM Optimizer 106, this component is configured to utilize the insights from the profiler report and code data flow that were produced by the Code Data Flow/Profiler Report/Graph Properties Module 105. Using this information, the LLM Optimizer 106 generates optimization strategies. Specifically, the LLM Optimizer 106 analyzes the patterns and structures within the code to propose efficient translations and optimizations. In the embodiment shown in FIG. 1, the LLM Optimizer 106 also receives input from the Accelerator Primitives/Hardware Properties Module 107.

Referring now to the Accelerator Primitives/Hardware Properties Module 107, in one or more embodiments this component is a database of hardware-specific functions and properties that is used to assist with code optimization. The Accelerator Primitives/Hardware Properties Module 107 contains information about the hardware’s capabilities, such as available operations, memory architecture, and special instructions. As shown in FIG. 1, the Accelerator Primitives/Hardware Properties Module 107 provides this information to the LLM Optimizer 106 to assist with the code optimization process.

After the optimized code leaves the LLM Optimizer 106, the optimized code then proceeds to Generation Planner 108. In some embodiments, the Generation Planner 108 also receives strategies suggested by the LLM Optimizer 106. Accordingly, the Generation Planner 108 creates a series of generation tasks that detail the specific changes to be made to the code, based on the strategies suggested by the LLM Optimizer 106. These series of generation tasks, and the current embodiment of the code, then proceed to the Generation Tasks Module 109. At the Generation Tasks Module 109, specific instructions for modifying the code are executed, which were generated by the Generation Planner 108. In some embodiments, these specific instructions involve, for example: restructuring loops, inlining functions, or other changes, which are designed to enhance performance or other selectable metrics, using hardware and algorithm specific optimizations.

Next, as shown in FIG. 1, the Code2Code Model 110 takes the generation tasks from the Generation Tasks Module 109 and applies them to the code. Thus, the Generation Tasks Module 109 transforms the code according to the planned optimizations. This ensures that the translated code remains semantically equivalent to the original code. In some embodiments, the Cached Generations 111 component is used to cache successful generations from the Code2Code Model 110. This enables the system 100 for hardware-in-the-loop AI feedback for processor-optimized code generation to avoid re-computation of code optimizations that have already been performed. Additionally, the Cached Generations 111 component is able to reference past successful optimizations for similar tasks in the future. From the Code2Code Model 110, the optimized code continues in a feedback loop 112 back to the beginning of the process with the Code Analyzer 101 and the Compiler 102.

In one or more embodiments, the system 100 for hardware-in-the-loop AI feedback for processor-optimized code generation operates in a cycle where the code is compiled, deployed, profiled, and then analyzed for optimization. The LLM suggests strategies, which are planned and then executed. Next, the results are fed back into the system 100 to inform further optimizations of the code. This process continues iteratively, with each cycle aiming to produce more efficient code tailored to the specific characteristics of the target hardware.

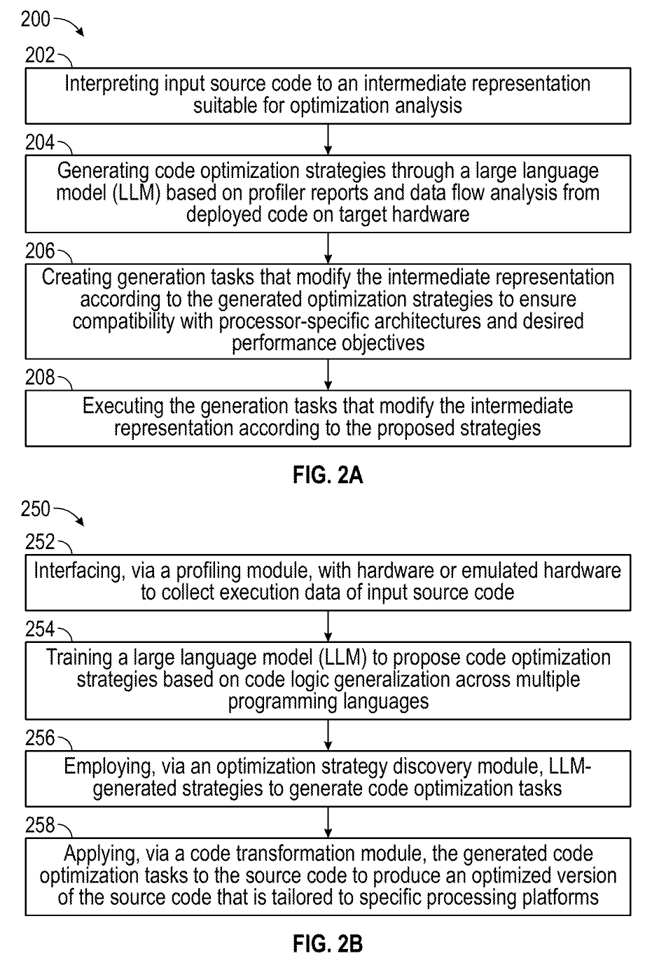

FIG. 2A is a flow diagram illustrating a method 200 for code generation process facilitated by hardware-in-the-loop feedback, according to some embodiments of the present disclosure. The method 200 can be performed by the system 100 as described with reference to FIG. 1.

The method 200 starts at block 202, where input source code is interpreted. As described above with reference to FIG. 1, the method includes interpreting input source code to an intermediate representation suitable for optimization analysis.

At block 204, the method 200 includes generating code optimization strategies. As described above with reference to FIG. 1, thegeneration of code optimization strategies is achieved through a large language model (LLM) based on profiler reports and data flow analysis from deployed code on target hardware.

At block 206, the method 200 includes creating generation tasks. As described above with reference to FIG. 1,creating generation tasks includes modifying the intermediate representation according to the generated optimization strategies to ensure compatibility with processor-specific architectures and desired performance objectives.

At block 208, the method 200 includes executing the generation tasks. As described above with reference to FIG. 1,executing the generation tasks includes modifying the intermediate representation according to the proposed strategies.

FIG. 2B is another flow diagram illustrating a method 250 for hardware-in-the-loop AI feedback using processor-optimized code generation with selectable objective metrics, according to some embodiments of the present disclosure. The method 250 can be performed by the system 100 as described with reference to FIG. 1.

The method 250 starts at block 252, where a profiling module is implemented. As described above with reference to FIG. 1, the method begins by interfacing, via the profiling module, with hardware or emulated hardware to collect execution data of input source code.

At block 254, the method 250 includes training a large language model (LLM). As described above with reference to FIG. 1, thelarge language model (LLM) is trained to propose code optimization strategies based on code logic generalization across multiple programming languages.

At block 256, the method 250 includes using an optimization strategy discovery module. As described above with reference to FIG. 1,an optimization strategy discovery module is employs LLM-generated strategies to generate code optimization tasks.

At block 258, the method 250 includes using a code transformation module. As described above with reference to FIG. 1,the code transformation module applies the generated code optimization tasks to the source code to produce an optimized version of the source code that is tailored to specific processing platforms.

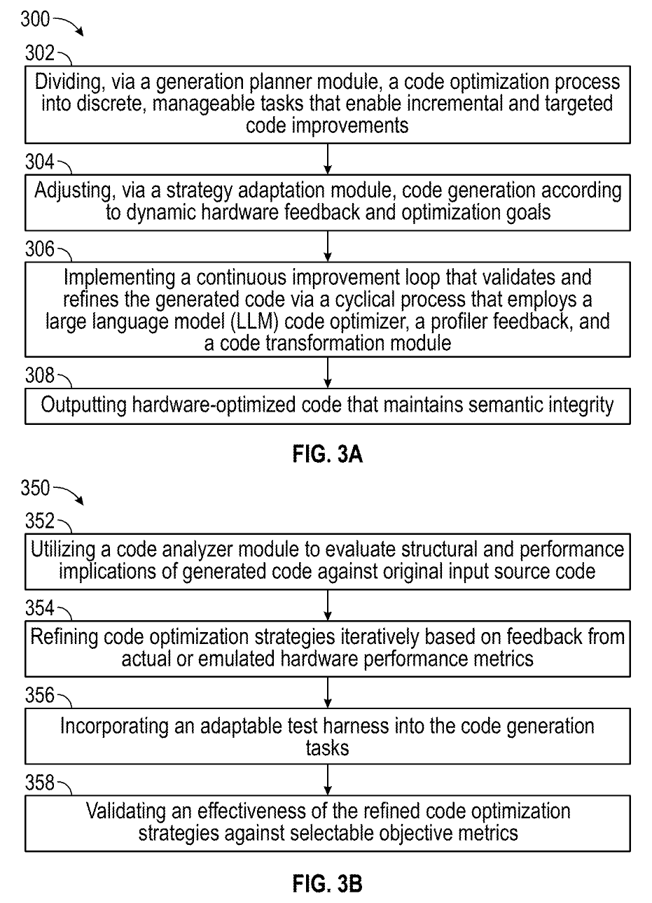

FIG. 3A is still another flow diagram illustrating a method 300 for iterative refinement to optimize code generation, according to some embodiments of the present disclosure. The method 300 can be performed by the system 100 as described with reference to FIG. 1.

The method 300 starts at block 302, where a generation planner module is implemented. As described above with reference to FIG. 1, the method begins by dividing, via the generation planner module, a code optimization process into discrete, manageable tasks that enable incremental and targeted code improvements.

At block 304, the method 300 implements a strategy adaptation module. As described above with reference to FIG. 1, thestrategy adaptation module adjusts code generation according to dynamic hardware feedback and optimization goals.

At block 306, the method 300 implements a continuous improvement loop. As described above with reference to FIG. 1,implementing a continuous improvement loop includes validating and refining the generated code via a cyclical process that employes a large language model (LLM) code optimizer, a profiler feedback, and a code transformation module.

At block 308, the method 300 includes outputting hardware-optimized code. As described above with reference to FIG. 1,the outputting of hardware-optimized code further includes maintaining semantic integrity.

FIG. 3B is yet another flow diagram illustrating a method 350 for verifying and optimizing processor-specific code generation, according to some embodiments of the present disclosure. The method 350 can be performed by the system 100 as described with reference to FIG. 1.

The method 350 starts at block 352, where a code analyzer module is utilized. As described above with reference to FIG. 1, the method begins by utilizing a code analyzer module to evaluate structural and performance implications of generated code against original input source code.

At block 354, the method 350 refines code optimization strategies. As described above with reference to FIG. 1, therefining of code optimization strategies is performed iteratively based on feedback from actual or emulated hardware performance metrics.

At block 356, the method 350 incorporates an adaptable test harness. As described above with reference to FIG. 1,an adaptable test harness is incorporated into the code generation tasks.

At block 358, the method 350 includes validating an effectiveness of the refined code optimization strategies. As described above with reference to FIG. 1,the validating of the effectiveness of the refined code optimization strategies is evaluated against selectable objective metrics. The selectable objective metrics include one or more of speed, energy efficiency, and resource utilization.

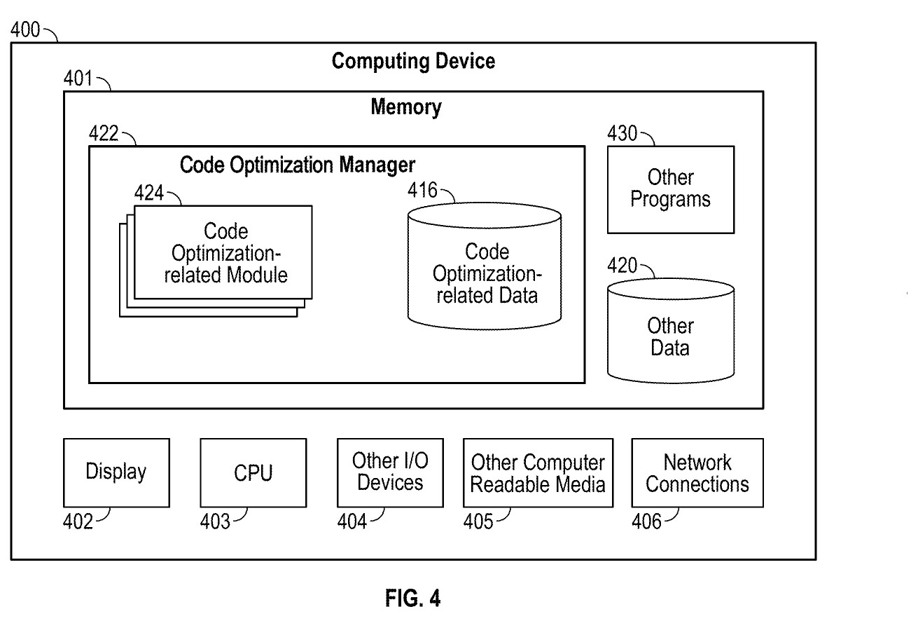

FIG. 4 is a block diagram illustrating a computing system or device 400 used to implement some or all the functionalities of the technology disclosed herein. According to some embodiments, one or more general purpose or special purpose computing systems or devices may be used to implement the computing device 400. In addition, according to some embodiments, the computing device 400 may comprise one or more distinct computing systems or devices and may span distributed locations. Furthermore, each block shown in FIG. 4 may represent one or more such blocks as appropriate to a specific embodiment or may be combined with other blocks. Also, the code generation process manager 422 may be implemented in software, hardware, firmware, or in some combination to achieve the capabilities described herein.

As shown, the computing device 400 includes a non-transitory computer memory (memory) 401, a display 402 (including, but not limited to a light emitting diode (LED) panel, cathode ray tube (CRT) display, liquid crystal display (LCD), touch screen display, projector, etc.), one or more Central Processing Units (CPU) or other processors 403, Input/Output (I/O) devices 404 (e.g., keyboard, mouse, RF or infrared receiver, universal serial bus (USB) ports, High-Definition Multimedia Interface (HDMI) ports, other communication ports, and the like), other computer-readable media 405, and network connections 406. The code generation process manager 422 is shown residing in memory 401. In other embodiments, some portion of the contents and some, or all, of the components of the code generation process manager 422 may be stored on or transmitted over the other computer-readable media 405. The components of the computing device 400 and code generation process manager 422 can execute on one or more CPUs 403 and implement applicable functions described herein. In some embodiments, the code generation process manager 422 may operate as, be part of, or work in conjunction or cooperation with other software applications stored in memory 401 or on various other computing devices. In some embodiments, the code generation process manager 422 also facilitates communication with peripheral devices via the I/O devices 404, or with another device or system via the network connections 406.

The one or more code generation process-related modules 424 are configured to perform operations related, directly or indirectly, to the code generation process, or other functionalities disclosed herein. In some embodiments, the code generation process-related module(s) 424 stores, retrieves, or otherwise accesses at least some code optimization-related data on some portion of the code optimization-related data storage 416 or other data storage internal or external to the computing device 400.

Other code or programs 430 (e.g., further data processing modules, a program guide manager module, a Web server, and the like), and potentially other data repositories, such as data repository 420 for storing other data, may also reside in the memory 401, and can execute on one or more CPUs 403. Of note, one or more of the components in FIG. 4 may or may not be present in any specific embodiment. For example, some embodiments may not provide other computer-readable media 405 or a display 402.

According to some embodiments, the computing device 400 and code optimization manager 422 include API(s) that provides programmatic access to add, remove, or change one or more functions of the computing device 400. In some embodiments, components/modules of the computing device 400 and code optimization manager 422 are implemented using standard programming techniques. For example, the code optimization manager 422 may be implemented as an executable running on the CPU 403, along with one or more static or dynamic libraries. In other embodiments, the computing device 400 and code optimization manager 422 may be implemented as instructions processed by a virtual machine that executes as one of the other programs 430. In general, a range of programming languages known in the art may be employed for implementing such example embodiments, including representative embodiments of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), or declarative (e.g., SQL, Prolog, and the like).

In a software or firmware embodiment, instructions stored in a memory configure, when executed, one or more processors of the computing device 400 to perform the functions of the code optimization manager 422. In some embodiments, instructions cause the CPU 403 or some other processor, such as an I/O controller/processor, to perform at least some functions described herein.

The embodiments described above may also use well-known or other synchronous or asynchronous client-server computing techniques. However, the various components may be implemented using more monolithic programming techniques as well, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs or other processors. Some embodiments may execute concurrently and asynchronously, and communicate using message passing techniques. Equivalent synchronous embodiments are also supported by a code optimization manager 422 embodiment. Also, other functions could be implemented or performed by each component/module, and in different orders, and by different components/modules, yet still achieve the functions of the computing device 400 and code optimization manager 422.

In addition, programming interfaces to the data stored as part of the computing device 400 and code optimization manager 422, can be available by standard mechanisms such as through C, C++, C#, and Java APIs; libraries for accessing files, databases, or other data repositories; scripting languages such as XML; or Web servers, FTP servers, NFS file servers, or other types of servers providing access to stored data. The model-related data storage 416 and data repository 420 may be implemented as one or more database systems, file systems, or any other technique for storing such information, or any combination of the above, including embodiments using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, and Web Services (XML-RPC, JAX-RPC, SOAP, and the like). Other variations are possible. Other functionality could also be provided by each component/module, or existing functionality could be distributed amongst the components/modules in different ways, yet still achieve the functions of the code optimization manager 422.

Furthermore, according to some embodiments, some or all of the components of the computing device 400 and code optimization manager 422 may be implemented or provided in other manners, such as at least partially in firmware or hardware, including, but not limited to one or more application-specific integrated circuits (ASICs), standard integrated circuits, controllers (e.g., by executing appropriate instructions, and including microcontrollers or embedded controllers), field-programmable gate arrays (FPGAs), complex programmable logic devices (CPLDs), and the like. Some or all of the system components or data structures may also be stored as contents (e.g., as executable or other machine-readable software instructions or structured data) on a computer-readable medium (e.g., as a hard disk; a memory; a computer network, cellular wireless network or other data transmission medium; or a portable media article to be read by an appropriate drive or via an appropriate connection, such as a DVD or flash memory device) so as to enable or configure the computer-readable medium or one or more associated computing systems or devices to execute or otherwise use, or provide the contents to perform, at least some of the described techniques.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

1. A method for code generation process facilitated by hardware-in-the-loop feedback, the method comprising:
interpreting input source code to an intermediate representation suitable for optimization analysis;
generating code optimization strategies through a large language model (LLM) based on profiler reports and data flow analysis from deployed code on target hardware;
creating generation tasks that modify the intermediate representation according to the generated optimization strategies to ensure compatibility with processor-specific architectures and desired performance objectives; and
executing the generation tasks that modify the intermediate representation according to proposed strategies.

2. The method of claim 1, further comprising: training the large language model (LLM) to propose code optimization strategies based on code logic generalization across multiple programming languages.

3. The method of claim 1, further comprising: refining the generated optimization strategies against selectable objective metrics.

4. The method of claim 3, wherein the selectable objective metrics include one or more of speed, energy efficiency, and resource utilization.

5. The method of claim 1, further comprising: outputting hardware-optimized code that is modified for processor-specific architectures and desired performance objectives.

6. A method for hardware-in-the-loop AI feedback using processor-optimized code generation with selectable objective metrics, comprising:
interfacing, via a profiling module, with hardware or emulated hardware to collect execution data of input source code;
training a large language model (LLM) to propose code optimization strategies based on code logic generalization across multiple programming languages;
employing, via an optimization strategy discovery module, LLM-generated strategies to generate code optimization tasks; and
applying, via a code transformation module, the generated code optimization tasks to the source code to produce an optimized version of the source code that is tailored to specific processing platforms.

7. The method of claim 6, wherein the LLM is trained on a multi-language data corpus for code-to-code translation.

8. The method of claim 6, further comprising: refining the LLM-generated strategies against selectable objective metrics.

9. The method of claim 8, wherein the selectable objective metrics include one or more of speed, energy efficiency, and resource utilization.

10. The method of claim 6, further comprising: outputting optimized version of the source code that is tailored to specific processing platforms.

11. A method for iterative refinement to optimize code generation, comprising:
dividing, via a generation planner module, a code optimization process into discrete, manageable tasks that enable incremental and targeted code improvements;
adjusting, via a strategy adaptation module, code generation according to dynamic hardware feedback and optimization goals;
implementing a continuous improvement loop that validates and refines the generated code via a cyclical process that employs a large language model (LLM) code optimizer, a profiler feedback, and a code transformation module; and
outputting hardware-optimized code that maintains semantic integrity.

12. The method of claim 11, further comprising: training the LLM code optimizer to propose strategies based on code logic generalization across multiple programming languages.

13. The method of claim 11, further comprising:refining the generated code against selectable objective metrics.

14. The method of claim 13, wherein the selectable objective metrics include one or more of speed, energy efficiency, and resource utilization.

15. The method of claim 11, further comprising: receiving input source code that is execution data from hardware or emulated hardware.

16. A method for verifying and optimizing processor-specific code generation, comprising:
utilizing a code analyzer module to evaluate structural and performance implications of generated code against original input source code;
refining code optimization strategies iteratively based on feedback from actual or emulated hardware performance metrics;
incorporating an adaptable test harness into code generation tasks; and
validating an effectiveness of the refined code optimization strategies against selectable objective metrics.

17. The method of claim 16, wherein the selectable objective metrics include one or more of speed, energy efficiency, and resource utilization.

18. The method of claim 16, further comprising: training an LLM code optimizer to propose the code optimization strategies based on code logic generalization across multiple programming languages.

19. The method of claim 16, further comprising: receiving original input source code that is execution data from hardware or emulated hardware.

20. The method of claim 16, further comprising: outputting hardware-optimized code that is modified for processor-specific architectures and desired performance objectives.
